(19) United States
(12) Patent Application Publication
(10) Pub. No.: US 2015/0028781 A1
(43) Pub. Date: Jan. 29, 2015

(54) METHOD FOR ACTUATING A BLDC MOTOR

(71) Applicant: MAGNA ELECTRONICS INC., Auburn Hills, MI (US)

(72) Inventors: Volker Steigerwald, Schollkrippen (DE); Mirko Kress, Goldbach (DE); Rudolf Polzer, Stein (DE)

(21) Appl. No.: 14/373,501

(22) PCT Filed: Jan. 9, 2013
(86) PCT No.: PCT/EP2013/050308

§ 371 Date: Jul. 21, 2014

(30) Foreign Application Priority Data
Jan. 24, 2012 (DE) 102012100579.6
Jun. 21, 2012 (DE) 102012210532.8

(51) Int. Cl. H02P 6/00

(52) U.S. Cl. CPC H02P 6/002
USPC 318/400.2

(57) ABSTRACT

A method for actuating a BLDC motor for reducing the current ripple in an intermediate circuit capacitor includes means for monitoring pulse width modulated signals (PWM_{U}, PWM_{V}, PWM_{W}) for each motor phase (U, V, W), which add motor phase currents Iᵤ, Iᵥ, I_{w}) of two adjacent phases in a first step, and add the respective pulse width modulated signals (PWM_{U}, PWM_{V}, PWM_{W}) if the added currents value is over zero, and shift the phase of at least one pulse width modulated signal (PWM_{U}, PWM_{V}, PWM_{W}) in the time slot T if the added signals result is greater than 1.

### CROSS REFERENCE TO RELATED APPLICATIONS

The present application is a 371 U.S. national phase application of PCT Application No. PCT/EP2013/050308, filed Jan. 9, 2013, which claims the filing benefit of German Application No. 102012210532.8, filed Jun. 21, 2012, and German Application No. 102012100579.6, filed Jan. 24, 2012.

### FIELD OF THE INVENTION

The invention relates to a method for energizing a brushless direct-current motor.

### STATE OF TECHNOLOGY

Generally the rotor of BLDC motors is implemented by means of a permanent magnet, the stationary stator comprises the coils actuated by an electronic circuit in offset time in order to generate a rotary field producing torque at the permanently excited rotor. For smaller BLDC motors with low demands such as fans, three-phase systems are customary due to their simple construction. In order to minimize angle dependent torque fluctuations, higher pole pair numbers are employed while, aside from the three-phase system customarily used in electrical engineering, a greater number of phases is also utilized. Running characteristics are improved by means of a higher pole number, so that the rotary field can also be generated via actuation with rectangular alternating voltage.

With BLDC motors it is possible to have electronic commutation depend on the position of the rotor, the speed of the rotor and the torque. This represents a type of direct feedback whereby the frequency, and with some systems also the amplitude, depending on the position and speed of the rotor, is changed. Electronic commutation therefore becomes a controller, and the way the rotary field is generated thus essentially defines the characteristics of a BLDC motor.

In order to capture rotor position and speed, different possibilities are available: sensor-controlled commutation and commutation without a sensor. Commutation describes the process in which the flow of the current transfers from one branch to the next. In the case of a 3-pole BLDC motor, the signal of the current advances by 60 electrical degrees.

In this case of sensor-controlled commutation, sensors such as, for example, Hall or optical sensors are located in the stator area in order to record the position of the rotor.

According to these position data, the windings, which generate torque in the rotor, are actuated via suitable power drivers by means of an electronic control system. It is advantageous that sensor-controlled commutation also functions at very low speed, respectively at stand-still. Generally not all phases are energized simultaneously when commutation is performed with three or more phases, but at least one phase is without current at any given time.

With sensorless commutation, the position of the rotor is captured by means of reverse voltage, which is generated by the stator's coils and analyzed by the electronic control system.

Via commutation cycles and disregarding harmonics generated by the pulse control, it is evident that the phase currents exhibit an approximately block-shaped or trapezoid progression. For this reason, the operation of brushless direct-current motors at a pulse control is also called “block commutation.”

The “advancement” of the current blocks by the pulse control corresponds to mechanical commutation with brush motors. Initial voltage supplied by the pulse controls consists of a sequence of (positive and negative) voltage impulses. If the pulse control is operated at a high pulse frequency, they are only slightly noticeable in the phase currents of connected motors and in the torque generated. Therefore demands for less ripple in torque can be very well accommodated. It is always a pulse control, however it comes down to how this pulse control is configured and actuated.

With block commutation, always exactly 2 or 3 motor phases are energized. It is entirely possible to execute block commutation by energizing three phases simultaneously. The third winding is not employed and used by several frequency inverters for measuring counter-electromotive force. Thereby, permanently excited machines can be commuted (optimally) by the frequency inverter without the position encoder otherwise required. Due to the permanently constant magnetic flux, there are hardly any disadvantages regarding the ripple of the torque or the level of efficiency when compared to sinusoidal commutation. By analogy to a multiphase motor, this type of operation is also called a 6-step-operation.

Sinusoidal commutation by means of a frequency inverter (sine-wave inverter; pulse widths are sinusoidally modulated) is customary for the operation of synchronous machines. Generally switch signals are generated by microcontrollers, which are available commercially specifically for motor applications in designs with 6 PWM outlets. It is not necessary to have 6 PWM outlets in order to have sinusoidal commutation.

Such a BLDC motor is known from the publication “PWM Switching Strategy for Torque Ripple Minimization”, W. Salah et al., Journal of Electrical Engineering, Vol 62, No. 3, 201 1, pages 141-146. A schematic diagram of such a motor is shown in its FIG. 2, which is cited as state of the art in FIG. 1 of this application.

The pulse width modulated signals used (pulse width modulation PWM) are configured such that the pulse height is modified during pulse time in order to reduce overly high current peaks, which are to be avoided, during the commutation's transitional phase. This affects current peaks in the supply line, not in the intermediate circuit of the motor.

Other methods for suppressing current ripple by adapting the pulse form are known.

### SUMMARY OF THE INVENTION

It is the purpose of the invention to overcome disadvantages of the known state of the art.

Specifically, its purpose is to reduce the current's ripple in the intermediate circuit of the motor and thus minimize the strain on components. By means of the invention's solution, components in the actuation process are released from strain in the intermediate circuit of the power supply, and it is possible to install smaller capacitors. Thus, installation space can be optimized, and components can be designed in smaller size. If the same dimensions are chosen for a component, then an extension of the component's lifespan can be achieved with the solution according to the invention.

The issue is solved with the characteristics of claim 1 as well as an accordingly designed controller.

The solution according to the invention proposes a control method for the inverter to optimize actuating signals such that PWM control pulses don't interfere with each other (in phase), but are out of phase, that is they overlie each other in a subtractive manner, which would cause the conventional actuation of current flow in two phases with the same sign.

It is advantageous that the method is independent of the chosen commutation and the type of brushless motor.

Commutation proceeds independent of the proposed method.

It is advantageous that the method can be employed with sensor-controlled as well as sensorless motors.

### BRIEF DESCRIPTION OF THE DRAWINGS

The invention is illustrated as examples in the drawings and further explained in the following description.

FIG. 1 shows the schematic view of an inverter.

FIG. 2 shows a supplemental schematic circuit diagram and temporal progression.

FIG. 3 shows schematic motor wiring.

FIG. 4 shows the reduction of an intermediate circuit capacitor's current.

FIG. 5 shows a flow chart.

FIG. 6 shows a phase shift of pulses.

### DESCRIPTION OF THE INVENTION

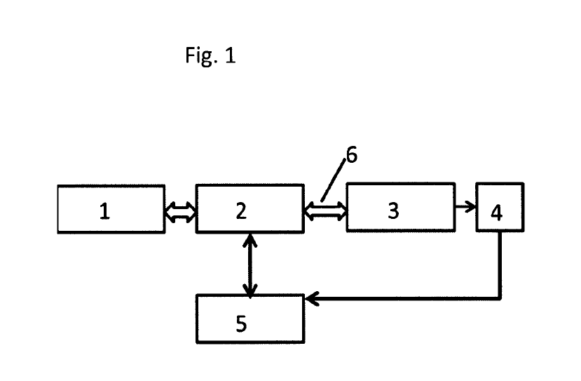

FIG. 1 shows power module 1 connected to inverter 2. The inverter is connected to motor 3 and controller 5. In this example, electric motor 3 exhibits a connection to sensor 4, which in turn is connected to controller 5.

Power module 1 serves as the power supply for the connected assemblies via an intermediate circuit and the voltage supply to the controller's electronic control system. The power module may, for example, contain a servo inverter based on a voltage source inverter. This means that capacitors maintain stable voltage in the intermediate circuit. Current peaks generated at the motor due to the signal's ripple kick back to the capacitors, so that their layout is also determined by the ripple dimensions.

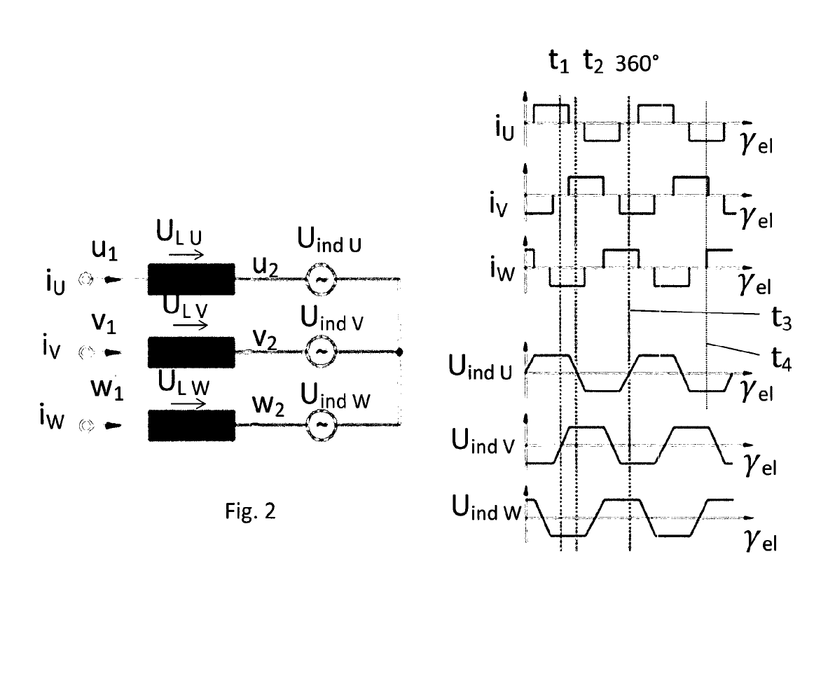

For example, motor 3 is actuated with pulse width modulated PWM signals in each motor phase. FIG. 2 shows an ideal condition with a supplemental schematic circuit diagram on the left side and the temporal (γ), ideal progression of motor phase currents Iᵤ, Iᵥ and I_{w} as well as motor phase voltages for an embodiment with block commutation. The temporal progression of motor phase currents is depicted in an ideal situation. Analogously, the motor is actuated with sinusoidal commutation. The different commutation sequences optimize the ripple of the current in the supply lines, but not in the intermediate circuit. If a reduction is made in the supply line, the intermediate circuit is automatically also affected, it depends on whether the optimized frequency spectrum is “buffered” more in the intermediate circuit or in the supply line.

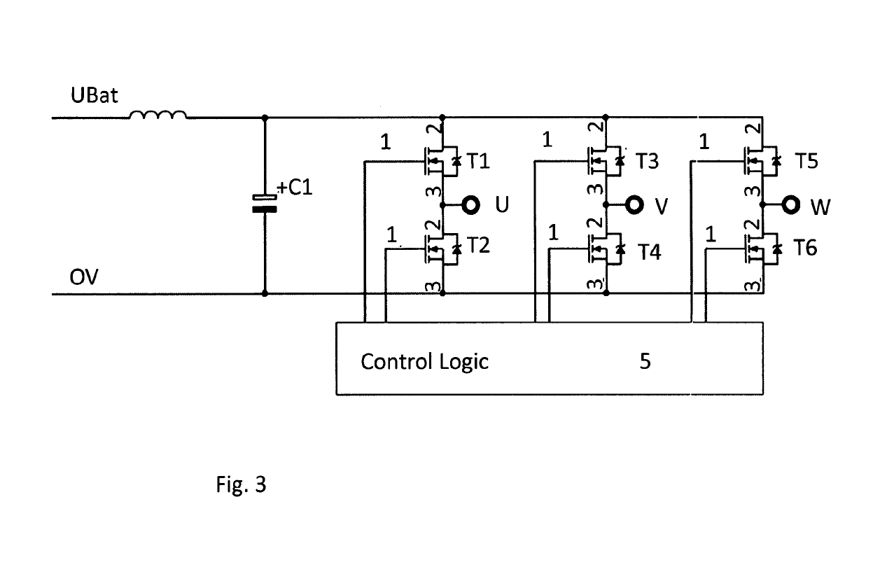

FIG. 3 shows a brushless motor connected with battery voltage U_{Batt}. An intermediate circuit is defined by means of coil L1 and capacitor C1. Parallel to the intermediate circuit are motor phases designated as U, V and W. They are actuated by power components T1 and T6. Power components T1 to T6 are directly connected with controller 5. Independent of the method of commutation as well as independent of a sensor or sensorless operation, motor phases (U, V, W) are actuated with the method according to the invention.

Controller 5 receives the data regarding motor phase currents Iᵤ, Iᵥ and I_{w} by means of a feedback channel. These currents flow between the values of −1 and 1 on a normed scale.

The total current I_{Bat} is between 0 and 1, the current in the intermediate circuit capacitor is designated I_{c}.

Actuation is done via PWM pulses on a normed scale between 1 and 0. The PWM pulses are correlated to the respective motor phase U, V, W.

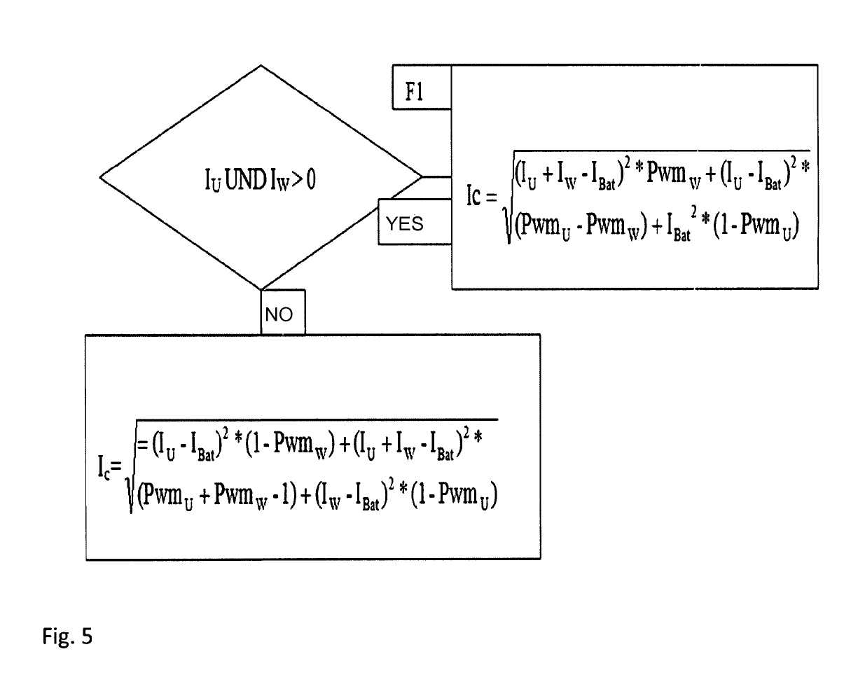

FIG. 5 illustrates the steps of this method. The currents of two consecutive motor phases in the example of phase U and phase W are added, and the result is checked logically. If the sum of the currents is less than zero, then current I_{c} flows in the intermediate circuit according to equation F1.

$$Ic = \sqrt{\begin{matrix}{( Iu + Iw - IBat )}^{2} * {PWM}_{w} + {( Iu - IBat )}^{2} * \\ ( PWMu - PWMw ) + {IBat}^{2} * ( 1 - PWM u )\end{matrix}}$$

If the sum of the currents is greater than zero, then a second logical step takes place. The controller checks the performance of the pulse width modulated signals PWMu and PWMw. If the sum of the pulse width modulated signals is less than 1, then current I_{c} flows in the intermediate circuit according to equation F2.

$$Ic = \sqrt{\begin{matrix}{( Iu - IBat )}^{2} * ( 1 - PWMw ) + {( Iu + Iw - IBat )}^{2} * \\ ( PWMu + PWMw - 1 ) + {( Iw - IBat )}^{2} * ( 1 - PWMu )\end{matrix}}$$

In both queries up to now, the pulse width modulated signal remains unchanged.

If, however, query PWMu+PWMw determines a value greater than 1, the pulses interfere with each other such that a peak in current would be generated. In this case, PWM packages are placed out of phase in order to avoid an addition in current.

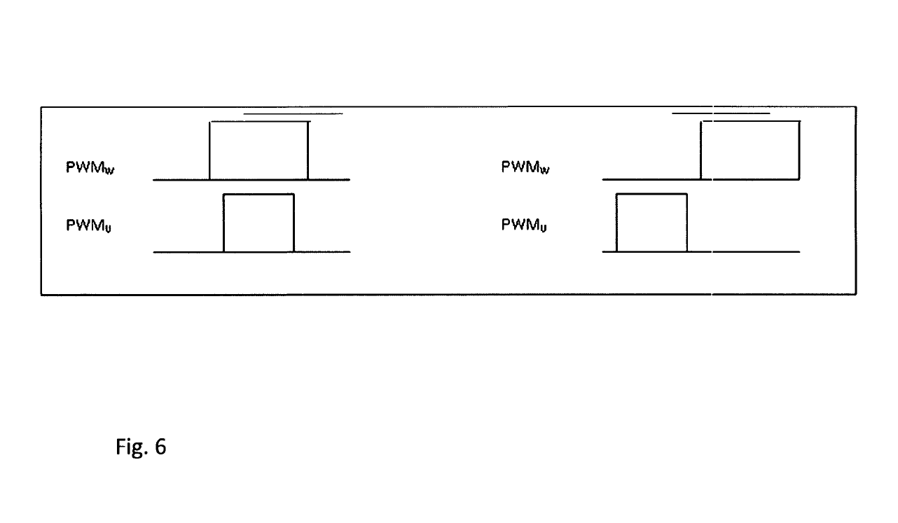

FIG. 6 shows the two scenarios on the left. The illustration depicts two PWM signals, which would be added. By offsetting pulse PWMu against PWMw, the currents are not added. This actuation by means of pulses is done in a section of the electric cycle and always in a defined partial slot of length T.

The proposed method can be implemented in the logic of a controller by means of suitable programming as well as in a circuit. Its implementation in software is done by means of a suitable programmable controller. It provides for the software used to execute the method to be saved in an EPROM or directly in the flash of the controller.

An implementation of the method into circuit design is largely dependent on the hardware used, the bridge drivers and the PWM module of the controller and is not further clarified individually. Any circuitry commonly known to a professional can be used to perform the above mentioned method steps.

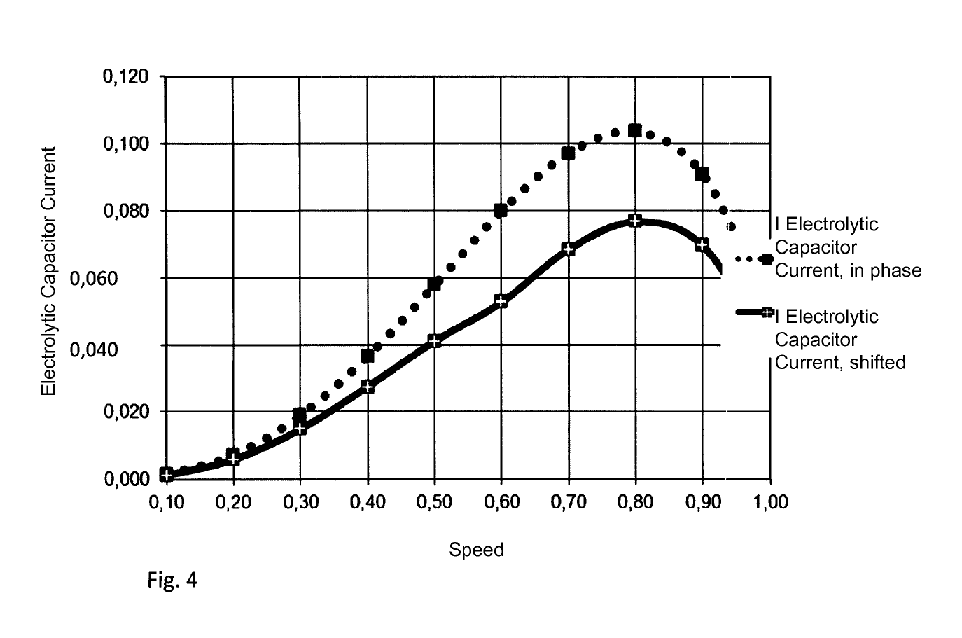

The result of the method described above can be seen in FIG. 4. The current in intermediate circuit I_{c} is entered above the motor's speed. The upper dotted line depicts the current's progress without employing the method according to the invention.

The solid line beneath represents an intermediate circuit's reduced current, which is obtained by employing the method and was measured for this example.

The invention is illustrated by means of examples and can be implemented and executed with any device commonly known to a professional.

1. A method for actuating a brushless direct-current motor (BLDC motor) for reducing the current ripple in an intermediate circuit capacitor, characterized in that devices to control pulse width modulated signals (PWMu, PWMv, PWMw) are available for each motor phase (U, V, W) and that, in a first step, motor phase currents (Iu, Iv, Iw) of two adjacent phases are added and, if the added value is above zero, then the respective pulse width modulated signals (PWMu, PWMy, PWMw) are added and if the result is greater than 1, then the phase of at least one pulse width modulated signal is offset in a time slot T.

2. The method for controlling a BLDC motor according to claim 1, characterized in that the means in a controller are implemented with software.

3. The method for controlling a BLDC motor according to claim 1, characterized in that the means are implemented with discreet or integrated circuitry.

4. The method for controlling a BLDC motor according to claim 1, characterized in that both phases of pulse width modulated signals (PWMu, PWMy, PWMw), located in time slot T, are offset against each other.

5. The method for controlling a BLDC motor according to claim 1, characterized in that only one phase of the pulse width modulated signals (PWMu, PWMv, PWMw), which is located in time slot T, is offset.

6. The method for controlling a BLDC motor according to claim 1, characterized in that the motor is block-commuted.

7. The method for controlling a BLDC motor according to claim 1, characterized in that the motor is sinusoidally commuted.

8. The method for controlling a BLDC motor according to claim 1, characterized in that the motor is energized without a sensor.

9. The method for controlling a BLDC motor according to claim 1, characterized in that the motor exhibits a sensor.

10. A controller for actuating a brushless direct-current motor (BLDC motor) for reducing the current ripple in an intermediate circuit capacitor, said controller comprising:
devices to control pulse width modulated signals (PWMu, PWMv, PWMw) available for each motor phase (U, V, W);
wherein, in a first step, the controller adds motor phase currents (Iu, Iv, Iw) of two adjacent phases;
wherein, if the added currents value is above zero, then the controller adds the respective pulse width modulated signals (PWMu, PWMy, PWMw); and
wherein, if the added signals value is greater than 1, then the controller offsets the phase of at least one pulse width modulated signal in a time slot T.

11. The controller for controlling a BLDC motor according to claim 10, wherein the controller includes software.

12. The controller for controlling a BLDC motor according to claim 10, wherein the controller includes discreet or integrated circuitry.

13. The controller for controlling a BLDC motor according to claim 10, wherein the controller offsets both phases of pulse width modulated signals (PWMu, PWMy, PWMw), located in time slot T, against each other.

14. The controller for controlling a BLDC motor according to claim 10, wherein the controller offsets only one phase of the pulse width modulated signals (PWMu, PWMv, PWMw), which is located in time slot T.

15. The controller for controlling a BLDC motor according to claim 10, wherein the motor is block-commuted.

16. The controller for controlling a BLDC motor according to claim 10, wherein the motor is sinusoidally commuted.

17. The controller for controlling a BLDC motor according to claim 10, wherein the motor is energized without a sensor.

18. The controller for controlling a BLDC motor according to claim 10, wherein the motor exhibits a sensor.
